(19) United States
(12) Patent Application Publication
(10) Pub. No.: US 2017/0184344 A1
(43) Pub. Date: Jun. 29, 2017

(54) SELF-COOLING BEVERAGE CONTAINER HAVING A HEAT EXCHANGE UNIT USING LIQUID CARBON DIOXIDE

(71) Applicant: JOSEPH COMPANY INTERNATIONAL, INC., Irvine, CA (US)

(72) Inventor: MARK SILLINCE, West Sussex (GB)

(73) Assignee: JOSEPH COMPANY INTERNATIONAL, INC., Irvine, CA (US)

(21) Appl. No.: 15/305,056

(22) PCT Filed: Apr. 29, 2015
(86) PCT No.: PCT/US15/28318

§ 371 Date: Oct. 18, 2016

Related U.S. Application Data
(60) Provisional application No. 61/986,422, filed on Apr. 30, 2014.
(60) Provisional application No. 62/014,556, filed on Jun. 19, 2014.

(51) Int. Cl. F25D 31/00; F25D 29/00; F25D 3/10; F25D 5/02; F16K 17/16; F16K 17/40

(52) U.S. Cl. CPC F25D 31/007; F16K 17/16; F16K 17/403; F25D 3/107; F25D 5/02; F25D 29/001; F25D 2331/805

(57) ABSTRACT

A container for food or beverage which has a heat exchange unit secured internally thereof to be in contact with the food or beverage, the heat exchange unit is filled with liquid carbon dioxide and has a valve which when activated allows the liquid carbon dioxide to pass from the liquid state directly to the gaseous state through a restricted orifice which functions to maintain residual carbon dioxide in the heat exchange unit in the liquid state until all of the liquid carbon dioxide is exhausted from the heat exchange unit.

### RELATED APPLICATIONS

This is the nonprovisional application based upon Provisional Application Ser. No. 61/986,422, filed Apr. 30, 2014, and Provisional Application Ser. No. 62/014,556, filed Jun. 19, 2014, and Applicant claims the benefits of the first filed filing date thereof.

### BACKGROUND OF THE INVENTION

### Field of the Invention

The present invention relates generally to containers for holding food or beverage in which there is also included a heat exchange unit using liquid carbon dioxide and having an outer surface which contacts the food or beverage and which when activated alters the temperature of the food or beverage.

It has long been desirable to provide a simple, effective and safe device which may be housed within a container such as a food or beverage container for the purpose of altering the temperature of the food or beverage on demand.

In many instances, such as where one is in locations where ice or refrigeration are not readily available such as camping, at the beach, boating, fishing or the like it is desirable to have beverages which can be cooled before consumption. In the past it has been necessary that the individual take an ice chest or the like which contains ice and the containers for the beverages so that they can be consumed in the manner desired. The utilization of such ice chests is cumbersome, takes up a substantial amount of space and lasts for only a very limited time after which the ice must be replaced. While in use it is also necessary that the water resulting from the melted ice be drained from the ice chest from time to time.

As a result of the foregoing, there have been numerous instances of attempts to provide a container housing a food or beverage and also housing therein a heat exchange unit which when activated would cool the food or beverage contained therein. The heat exchange units in such prior art devices housed a refrigerant material usually under pressure which when released would absorb the heat in the surrounding food or beverage thereby cooling the same prior to consumption. The refrigerants utilized in the heat exchange units of the prior art included gases under pressure such as hydroflourocarbons, ammonia, liquid nitrogen, carbon dioxide, and liquid carbon dioxide. There has also been developed a system using compacted carbon particles which adsorb carbon dioxide gas under pressure. When the HEU is exposed to the atmosphere by opening a valve, the carbon dioxide gas desorbs and cools the food or beverage in the container. Examples of such systems are shown in U.S. Pat. Nos. 7,185,511, 6,125,649 and 5,692,381. Examples of such prior art patents including carbon dioxide in its gas or liquid form is shown by U.S. Pat. Nos. 3,373,581; 4,688,395; and 4,669,273. The containers utilizing such heat exchange units as illustrated in the prior art are complex and difficult to manufacturer, thus causing great expense, rendering such prior art self-chilling beverage containers commercially unattractive. In addition, where liquid carbon dioxide was utilized, the release of the liquid carbon dioxide resulted in the liquid carbon dioxide transitioning into the solid state which provided only limited reduction in temperature of the food or beverage. As a result of the foregoing there exists a need for a simple, easy to assemble and efficient self cooling system for a food or beverage.

### SUMMARY OF THE INVENTION

A food or beverage containing assembly comprising an outer container for receiving a food or beverage and having a top and a bottom, the bottom defining an opening therethrough, a heat exchange unit (HEU) including a metallic inner container filled with liquid carbon dioxide (CO2) and adapted to be secured to the outer container in the opening. A valve means secured to said HEU for providing a restricted orifice which, when activated, creates a dis-equilibrium to permit the liquid CO2 to pass directly from the liquid state to the gaseous state but at the same time maintains the CO2 in the HEU in its liquid state.

### BRIEF DESCRIPTION OF THE DRAWINGS

FIG. 1 is a phase diagram of carbon dioxide illustrating the pressure and temperature at which the CO2 is solid, liquid, gas and supercritical fluid;

FIG. 2 is a partial cross-sectional view illustrating one embodiment of a valve for providing the restricted orifice in its closed position;

FIG. 3A is a partial cross-sectional view of the valve of FIG. 2 in its open position;

FIG. 3B is an enlarged partial view of the valve of FIG. 3A;

FIG. 4 is an alternative embodiment of a valve system for providing the restricted orifice;

FIG. 5 is another embodiment of a valve system;

FIG. 6 is yet another embodiment of a valve system;

FIG. 7 is a partial cross-sectional view showing one embodiment of a self-chilling beverage container constructed in accordance with the principles of the present invention;

FIG. 8 is a cross-sectional view showing in greater detail the portion of FIG. 7 illustrated in the circle 8-8;

FIG. 9 is a perspective view of an attachment adapter utilized in the structure as illustrated in FIG. 8; and

FIG. 10 is a perspective view of a molded plastic valve element of the present invention.

### DETAILED DESCRIPTION OF THE INVENTION

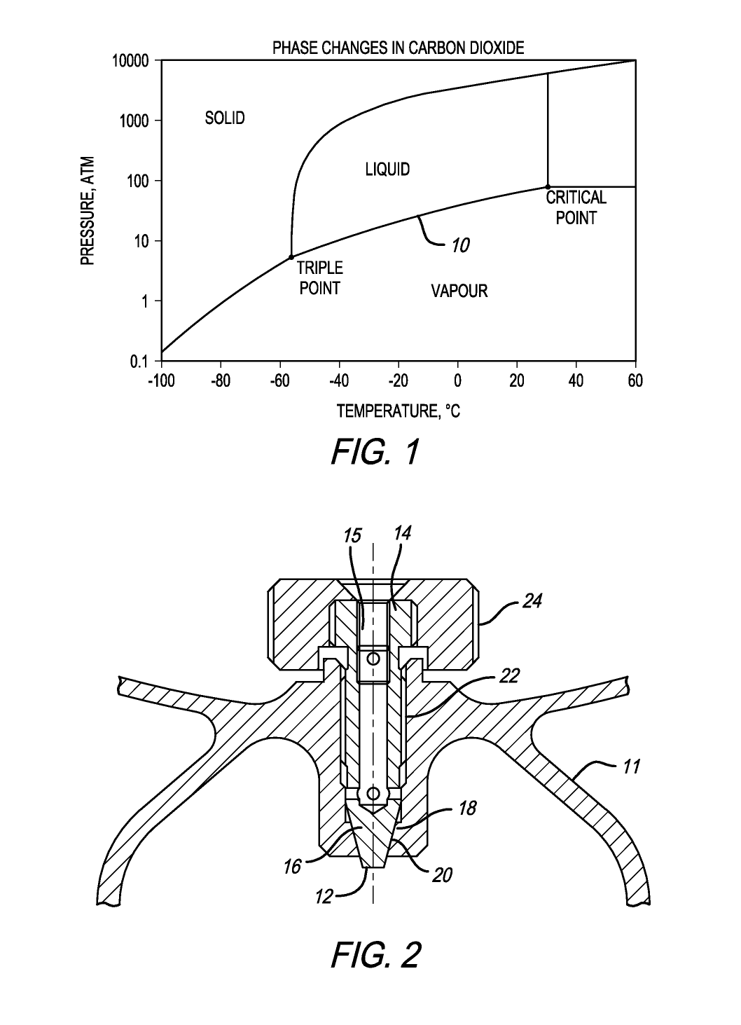

Referring now more particularly to FIG. 1, there is illustrated a phase diagram for carbon dioxide. As is therein illustrated, the carbon dioxide may have a solid phase, a liquid phase or a vapor or gas phase. In accordance with the principles of the present invention it is critical that the carbon dioxide be maintained in its liquid phase and prevented from passing into a solid phase where dry ice is formed during the time that the heat exchange unit is being utilized to lower the temperature of the food or beverage within the container. As is shown, the triple point on the phase diagram is the point at which the three states of matter (gas, liquid and solid) coexist. The critical point is the point on the phase diagram at which the substance, in this instance the carbon dioxide, is indistinguishable between liquid and gaseous states. The vaporization (or condensation) curve is the curve 10 on the phase diagram which represents the transition between the liquid and vapor or gaseous states. As is shown, the phase diagram plots pressure typically in atmospheres versus temperature, in this case, in degrees Celsius. The lines represent the combinations of pressures and temperatures at which two phases can exist in equilibrium. In other words, these lines define phase change points. In accordance with the principles of the present invention, the heat exchange unit is charged with carbon dioxide at a temperature and pressure such that the carbon dioxide is in its liquid state. The heat exchange unit is then sealed so that the liquid state is retained in equilibrium within the heat exchange unit until such a time as it is desired to cool the food or beverage within the container which surrounds the heat exchange unit. At that point, dis-equilibrium is created so that the liquid carbon dioxide is allowed to pass into the vapor or gaseous state but at the same time it is critical that the pressure within the heat exchange unit is maintained such that any carbon dioxide which still exists within the heat exchange unit is maintained in its liquid state. This is accomplished, as will be described in greater detail hereinbelow, by providing a path for the liquid carbon dioxide to pass from its liquid to its gaseous state and exhaust to the atmosphere by passing through a restricted orifice which has a pressure drop such that the pressure within the heat exchange unit is maintained so that the residual carbon dioxide which is contained within the heat exchange unit remains in its liquid state until such a time as all of the liquid carbon dioxide passes from the liquid state to the gaseous state and exhausts through the restricted orifice to the atmosphere, thereby completely exhausting the liquid carbon dioxide in the heat exchange unit.

Referring now more particularly to FIG. 2, there is illustrated in schematic form a heat exchange unit 11 which has one embodiment of a valve mechanism secured thereto which may be utilized to provide the restricted orifice necessary to maintain the CO2 within the HEU in its liquid state and at the same time create a dis-equilibrium to permit the liquid CO2 to pass from the liquid state to the gaseous state and exhaust from the HEU. The valve defines an opening 15 through which liquid CO2 under pressure may be inserted into the HEU 11 to charge it to the equilibrium state. As is illustrated in FIG. 2, the valve mechanism has first 12 and second 14 ends. The first end 12 terminates in a tapered fashion as shown at 16 and has a surface 18 which when fully seated on the valve seat 20 seals the interior of the HEU preventing the liquid CO2 from escaping and thus being maintained in its liquid state. This is accomplished by providing threads, as shown at 22, so that when the activation wheel 24 which is secured to the second end 14 of the valve mechanism is rotated the surface 18 is moved downwardly, it will sealingly engage the valve seat 20 but when the activation wheel 24 is rotated in the opposite direction, the surface 18 is moved away from the valve seat 20 and provides a path for the liquid CO2 to pass from the liquid to the gaseous state.

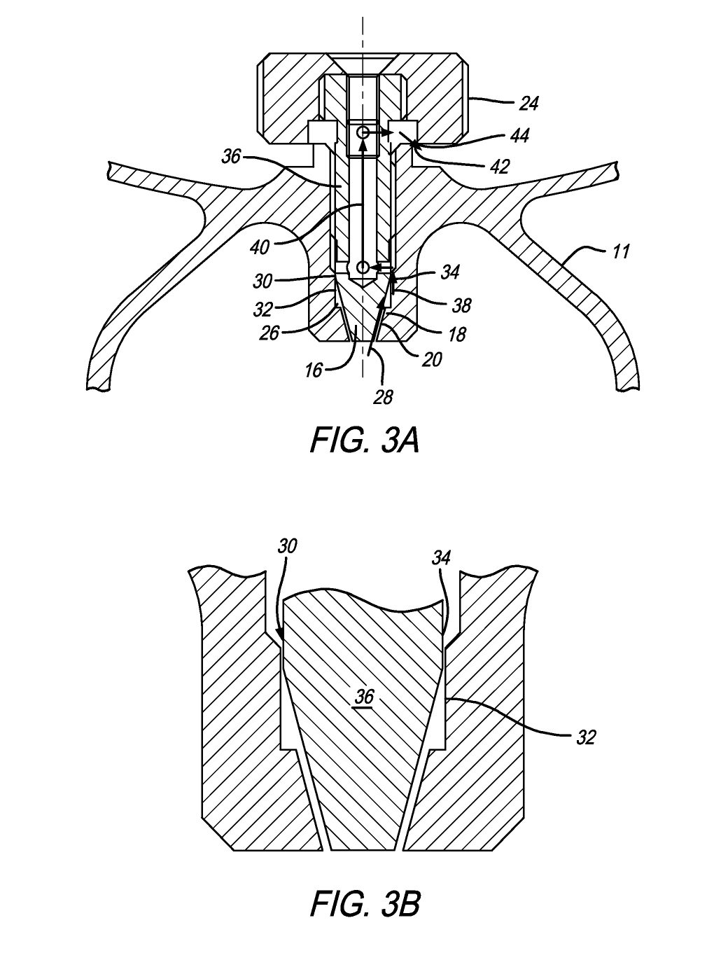

The opening of the valve mechanism to provide the restricted orifice allowing the gaseous CO2 to escape from the HEU and pass into the atmosphere is shown in FIG. 3A to which reference is hereby made. As is illustrated, the tapered portion 16 has now been moved upwardly away from the valve seat 20 by rotation of the activation wheel 24 thereby providing a path 26 through which the gaseous carbon dioxide may pass and such is illustrated by the arrow 28. A restricted orifice 30 is provided between the surface 32 and the edges 34 of the valve 36. The gaseous CO2 passes through the restricted orifice 30 as shown by the arrow 38, through the center portion of the valve 36 as shown by the arrow 40 and then passes outwardly through an opening 42 provided adjacent the activation wheel 24 thus permitting the carbon dioxide in its gaseous state to exit to the atmosphere as illustrated by the arrow 44. It will be recognized by those skilled in the art that by providing the restricted orifice 30 as above described, a pressure drop is created which will be reflected in the body of the HEU to an extent such that the carbon dioxide remaining in the interior of the HEU is maintained in its liquid state.

By reference now more specifically to FIG. 3B, the valve as illustrated in FIGS. 2 and 3A is shown in an enlarged partial cross-sectional view and the restricted orifice 30 is more clearly visible. As is shown in FIG. 3B, the restricted orifice 30 created by moving the plug upwardly by an amount of, in this instance one thread, a gap of 12 microns is provided between the valve edge 34 and the surface 32. The length of the restricted orifice 30 is 0.4 millimeters, thereby providing an annulus volume of 0.0377 cubic millimeters. The structure which has been manufactured as a prototype utilizing an HEU having an internal volume of 199 cubic centimeters and a displacement of 250 cubic centimeters placed within an outer container having an amount of beverage of 250 cubic centimeters and with the HEU charged with liquid carbon dioxide between 100 and 120 grams, provided 20° C. cooling at between 1 and 2 minutes until the liquid carbon dioxide is fully spent without the formation of solid CO2. That is the pressure drop across the restricted orifice 30 maintained the CO2 within the HEU in its liquid state and allowed the dis-equilibrium created by the opening of the restricted orifice 30 to cause the transition of the liquid CO2 to the gaseous state to pass along the line 10 as shown in FIG. 1 even as the temperature and the pressure changed as a result of the creation of the restricted orifice 30 and the cooling effect created.

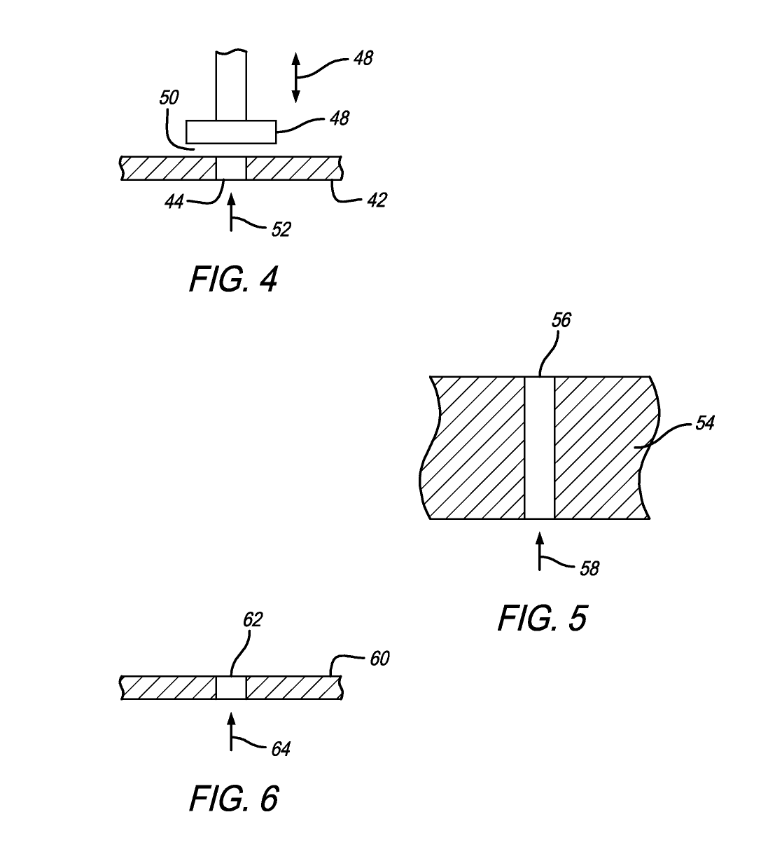

It should be understood by those skilled in the art that even though a valve as shown in FIGS. 2 and 3 has been constructed and utilized in the prototype of the present invention that other mechanisms may be utilized to create the desired restricted orifice and create the necessary pressure drop so that the carbon dioxide retained within the HEU is maintained in its liquid phase. One example of a mechanism which can be utilized to create the restricted orifice and allow operation of the HEU as above described is shown in schematic form in FIG. 4. As therein shown, there is a member 42 which has an orifice 44 of the desired size to create the pressure drop as above described. A plunger 46 is disposed above the orifice 44 and when in its fully downward position and seated against the member 42, the orifice 44 is closed and sealed. When the plunger 46 is moved upwardly as shown by the arrow 48, by a sufficient amount there is then created a flow path 50 of a desired amount so that the restricted orifice is defined over the required distance to create the pressure drop as above described. Those skilled in the art will recognize many mechanisms, such as threads, ratchet or the like, which may be utilized to cause the plunger 46 to move upwardly or downwardly as shown by the arrow 48 to seal and unseal the orifice 44 thus allowing the creation of the restricted orifice to provide a flow path for the carbon dioxide to pass from the liquid to the gaseous state and out to atmosphere as shown by the arrow 52.

Reference is now made to FIG. 5 which also shows a different mechanism for providing the restricted orifice and this would include a body of material 54 having an orifice 56 formed therein of a sufficient length and in combination with the diameter of the orifice 56 would provide the pressure drop as above discussed to maintain the carbon dioxide in its liquid form throughout the operation of the device by providing a flow path 58 for the carbon dioxide when it passes from its liquid to its gaseous state to be exhausted to the atmosphere. An appropriate plunger or plug (not shown) would be utilized to seal the orifice 56 while the system was maintained in its equilibrium state.

An additional further embodiment of a structure to provide the desired restricted orifice is shown in FIG. 6 to which reference is hereby made. As is therein shown, there is provided a membrane 60 which has a pin hole 62 formed therein which can be accomplished by an appropriate plunger or other mechanism that is activated by the user when it is desired to cool the food or beverage contained within the container. When the orifice 62 is generated, a flow path 64 is then provided so that the carbon dioxide may move from its liquid state to its gaseous state and be exhausted to the atmosphere as above discussed.

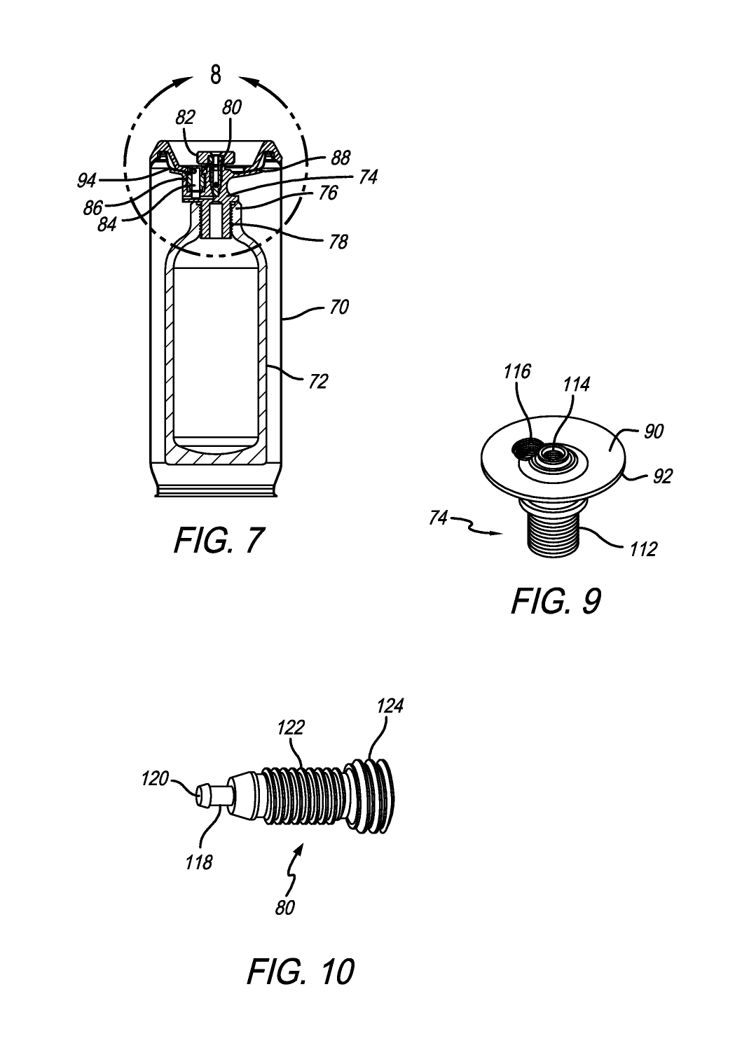

Referring now more particularly to FIG. 7, the completed structure of one embodiment of a beverage can with the HEU secured internally thereof is illustrated in cross section. As therein shown, the beverage can 70 with the HEU 72 secured internally thereof by an attachment adapter 74 which is threadably secured to the top 76 of the HEU 72. The attachment adapter 74 is secured to the top 76 of the HEU by threads 78 shown therein. A valve 80 is threaded into the top of the attachment adapter 74 and secured to the top of the valve is an activation wheel 82. The activation wheel 82 is utilized to move the valve 80 to seal the valve or to open it to allow the liquid CO2 contained within the HEU 72 to pass from the liquid to the gaseous state as above described. A safety burst disc assembly 84 is also threadably secured to the attachment adapter 74 by the threads 86. The attachment adapter with the release valve and the safety burst disc assembly is secured to the beverage can 70 at the interface 88 formed by the surface 90 (FIG. 9) on the flange 92 of the attachment adapter 74 and the surface 94 on the beverage can 70. The securing mechanism may be an adhesive or fastener.

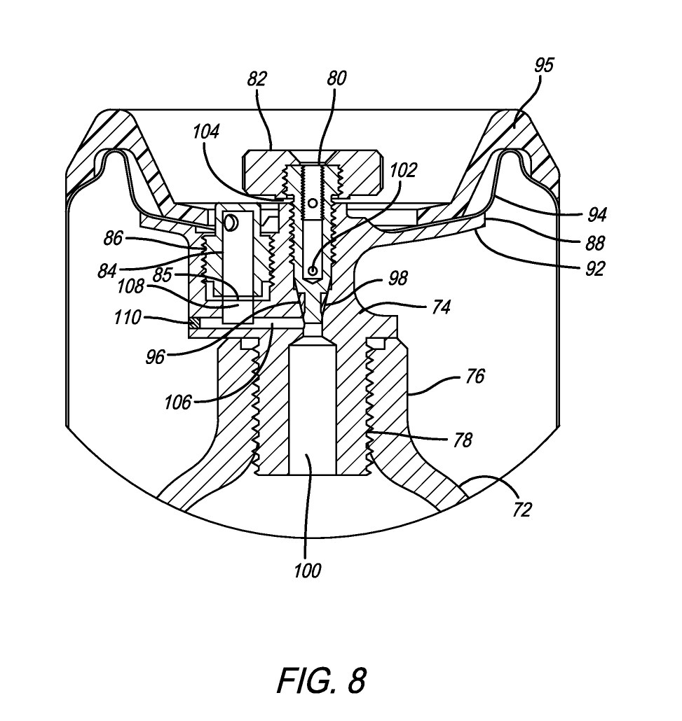

Referring now more specifically to FIG. 8, the structure as shown in FIG. 7 is illustrated in better detail. As is shown, the valve 80 includes an insert 96 of polytetraflouroethyene (PTFE) which is utilized to create a seal between the lower part of the valve 80 and acts as a seal against the valve seat 98 defined by the attachment adapter 74. When the activation wheel 82 is rotated in a counterclockwise direction, the insert 96 will be removed from the valve seat 98 by an amount sufficient to provide the restricted orifice above described allowing the liquid CO2 to pass from the liquid to the gaseous state and to progress through the opening 100 in the attachment adapter 74 and pass through openings provided in the wall of the valve 80, one of which is shown at 102 to then pass through the opening 104 at the top part of the valve and to pass into the atmosphere. The burst disc assembly 84 includes a disc 85 which is exposed continuously to the pressure contained within the HEU by way of the conduit 106 which then allows the pressure to enter into the channel 108 within the burst disc assembly to be in contact with the burst disc itself so that if the pressure does build to an undesirable amount, the burst disc will rupture, releasing the unwanted pressure. A plug is welded at the end of the conduit 106 as is indicated at 110 to prevent escape of the liquid CO2 and assure that the pressure thereof engages the burst disc. A molded plastic cap 95 is fitted over the bottom of the container 70 so that the completed assembly will be stable when placed in a display position for sale or the like.

By reference now to FIG. 9, the attachment adapter 74 is shown in perspective view. As is therein indicated, the adapter 74 includes the flange 92 which has the upper surface 90 that engages the lower surface 94 of the beverage can to provide the attachment of the attachment adapter 74 to the beverage can 70. The lower extension 112 of the attachment adapter 74 is threaded as is illustrated in FIG. 9 so that the attachment adapter may be threadably secured to the top surface 76 of the HEU 72 as above described. The attachment adapter 74 defines a first opening 114 which also includes the threaded internal surface and into which the release valve 80 is threaded. A second opening 116 is also provided in the body of the attachment adapter 74 and receives the safety burst disc assembly 84 by way of threads provided internally of the opening 116. As illustrated in FIG. 9, the assembly of the release valve and the safety burst disc may be constructed prior to attaching the attachment adapter to the upper end of the heat exchange unit 72. This will enable easier construction of the device as illustrated above.

By reference now to FIG. 10, the PTFE version of the valve 80 is illustrated in perspective view. The structure as shown in FIG. 10 is preferably molded from the

PTFE plastic material and as shown, a reduced diameter section 118 is provided to receive the additional PTFE insert 96 and is provided at the lower end 120 of the valve 80. As is also shown, the threads 122 are utilized to engage the valve with the attachment adapter 74 while the threads 124 are utilized to allow the activation wheel 82 to be secured to the top of the valve 80.

There has thus been described a structure of a self-chilling food or beverage container having an outer container having a heat exchange until including an inner container secured therein by means well known to those skilled in the art and which is charged with carbon dioxide in its liquid state which is allowed to pass from the liquid to the gaseous state through a restricted orifice which provides a pressure drop to maintain the carbon dioxide remaining within the HEU in its liquid state until it is fully exhausted thereby cooling the contents of the food or beverage housed within the outer container.

What is claimed is:

1. A self-chilling food or beverage container having a heat exchange unit using liquid carbon dioxide comprising:
an outer container for receiving a food or beverage;
a heat exchange unit including an inner container secured to said outer container and extending into said outer container so that an outer surface thereof is in contact with a food or beverage received within said outer container;
a valve secured to said inner container adapted to permit liquid carbon dioxide to be inserted into said inner container and having a first position so that liquid carbon dioxide in said inner container is retained at a pressure and temperature to remain in equilibrium in said liquid state;
said valve having a second position defining a restricted orifice to generate dis-equilibrium to cause said liquid carbon dioxide to pass into the gaseous state and exhaust to the atmosphere through said restricted orifice thereby chilling the food or beverage while retaining any residual carbon dioxide in said inner container in the liquid state; and
means for moving said valve between said first and said second positions.

2. A self-chilling food or beverage container as defined in claim 1 which further includes a burst disc secured to said inner container which is in constant communication with said liquid carbon dioxide and is adapted to rupture if the pressure of said liquid carbon dioxide exceeds a predetermined amount.

3. A self-chilling food or beverage container as defined in claim 2 which further includes an attachment adapter secured to said inner container, said valve and said burst disc being carried by said attachment adapter.

4. A self-chilling food or beverage container as defined in claim 3 wherein said valve includes a molded plastic member which seats against a first surface of said attachment adapter to provide said first position and cooperates with a second surface of said attachment adapter to provide said restricted orifice.

5. A self-chilling food or beverage container as defined in claim 4 wherein said outer container has a bottom surface defining an opening therein and said attachment adapter is disposed adjacent said opening.

6. A self-chilling food or beverage container as defined in claim 5 wherein said attachment adapter includes an outwardly extending flange having a top surface, said top surface being seated against the bottom surface of said outer container around said opening.

7. A self-chilling food or beverage container as defined in claim 1 which further includes an attachment adapter defining a first opening therein providing a valve seat and secured to said inner container, said valve is a molded plastic member having first and second ends and threads thereon and said first end terminating in a tapered portion, said valve being threadably received within said first opening in said attachment adapter, said tapered portion of said valve when fully seated on said valve seat providing said first position of said valve, an activation wheel affixed to the second end of said valve for rotating said valve on the threads thereon, said tapered portion with said valve seat forming said restricted orifice when said activation wheel is rotated to move said tapered portion away from said valve seat.

8. A self-chilling food or beverage container as defined in claim 7 which further includes a molded plastic insert member and wherein said tapered portion of said valve includes a reduced diameter section, said plastic insert member being received within said reduced diameter section and functions to provide a seal against said valve seat when said valve is in said first position.

9. A self-chilling food or beverage container as defined in claim 8 which further includes a burst disc, said attachment adapter defining a second opening therein, said burst disc being received within said second opening, said burst disc being in constant communication with said liquid carbon dioxide and adapted to rupture if the pressure of said liquid carbon dioxide exceeds a predetermined amount.

10. A self-chilling food or beverage container as defined in claim 9 wherein said inner container includes a threaded opening therein, said attachment adapter has a threaded extension thereon which is threadably received within said threaded opening in said inner container to secure said valve and said burst disc to said inner container.

11. A self-chilling food or beverage container as defined in claim 1 which further includes an attachment adapter defining an opening therein, said valve being received within said opening, said valve when in said second position having a surface cooperating with at least a portion of said opening to provide said restricted orifice.

12. A self-chilling food or beverage container as defined in claim 11 wherein the distance between said valve surface and said portion of said opening is 12 microns and extends over 0.4 mm to provide said restricted orifice.
